(19) United States
(12) Patent Application Publication
(10) Pub. No.: US 2006/0291142 A1
(43) Pub. Date: Dec. 28, 2006

(54) Composite material containing nanotubes and an electrically conductive polymer

(75) Inventors: Leonid Grigorian, Columbus, OH (US); Toshio Tokune, Columbus, OH (US); Arthur J. Epstein, Bexley, OH (US)

Correspondence Address: FITCH, EVEN, TABIN & FLANNERY, P. O. BOX 18415, WASHINGTON, DC, 20036, US

(73) Assignees: Ohio State University Research Foundation; Honda Motor Co., Ltd.

(21) Appl. No.: 11/178,349

(22) Filed: Jul. 12, 2005

Related U.S. Application Data
(60) Provisional application No. 60/635,008, filed on Dec. 13, 2004.

(51) Int. Cl. H01G 9/00

(52) U.S. Cl. 361/503

(57) ABSTRACT

The present teachings are directed toward composite materials containing nanotubes and an electrically conductive polymer, poly(3,4-ethylenedioxythiopene), and devices, such as capacitors, containing the composite materials.

### BACKGROUND

1. Field of the Invention

The present teachings relate to composite materials containing nanotubes and an electrically conductive polymer material, poly(3,4-ethylenedioxythiopene).

2. Discussion of the Related Art

It is well known in the art that carbon nanotubes can exhibit semiconducting or metallic behavior. Additional properties that make carbon nanotubes of interest are high surface area, high electrical conductivity, high thermal conductivity and stability, and good mechanical properties. See U.S. Patent Application Publication US 2003/0164427 A1.

Intrinsically conductive organic polymer materials, such as, polyaniline, polythiopene, polypyrrole, and polyacetylene have also been known. See Electrical Conductivity in Conjugated Polymers, Arthur J. Epstein in “Conductive Polymers and Plastics” edited by L. Rupprecht, RTP Company (1999).

Orientation and interaction between individual nanotubes within a polymeric matrix can influence greatly the resulting physical properties and characteristics of the composite material. Oriented nanotubes are discussed, for example, in U.S. Pat. No. 6,265,466. Possible effects of interactions between individual nanotubes are discussed, for example, in U.S. Patent Application Publication No. US 2003/0008123 A1.

Materials can provide a capacitance function, by means of, a variety of methods and combinations of methods, for example, by pseudocapacitance, or by means of double layer capacitance. Pseudocapacitance is caused by a charge-transfer chemical reaction that involves ionic transport across the electrode-electrolyte interface. The charge-transfer chemical reaction can even involve ionic transport into the bulk of the electrode. In contrast, double layer capacitance is caused by the polarization of conducting electrons on the surface of the electrode material that is in contact with the electrolyte.

A need exists for a composite material which incorporates nanotubes into an electrically conductive polymeric material in such a manner to produce a material with increased capacitance over existing materials.

### SUMMARY

The present teachings meet the need for a composite material with unexpectedly increased capacitance over existing materials.

The composite material of the present teachings can include a plurality of nanotubes, and an electrically conductive polymeric matrix, such as poly(3,4-ethylenedioxythiopene), (herein referred to as “PEDOT”). The composite material can further include a counterion.

The present teachings further include a capacitor having a first electrode comprising a composite material comprising a plurality of nanotubes, an electrically conductive polymeric matrix, such as poly(3,4-ethylenedioxythiopene), and a counterion; an electrolyte; and a second electrode.

### BRIEF DESCRIPTION OF THE DRAWINGS

The accompanying drawings, which are included to provide a further understanding of the present teachings and are incorporated in and constitute a part of this specification, illustrate various embodiments of the present teachings and together with the detailed description serve to explain the principles of the present teachings. In the drawings:

FIG. 1 illustrates Raman spectrum of RFP (defined below) single-walled carbon nanotubes, poly(3,4-ethylenedioxythiopene), and a composite material according to the present teachings;

FIG. 2 illustrates Raman spectra of three different spots or flakes of the same composite material tested in FIG. 1, and RFP single-walled carbon nanotubes;

FIG. 3 illustrates Raman spectra of two different spots or flakes of a composite material according to the present teachings, and RFP single-walled carbon nanotubes;

FIG. 4 illustrates cyclic voltammetric test results for two different RFP single-walled carbon nanotube and poly(3,4-ethylenedioxythiopene) composite materials; and

FIG. 5 illustrates capacitance test results for poly(3,4-ethylenedioxythiopene), RFP single-walled carbon nanotubes, a RFP single-walled carbon nanotube and poly(3,4-ethylenedioxythiopene) composite material, and a commercially available activated carbon material.

### DETAILED DESCRIPTION

The present teachings relate to composite materials including nanotubes and an electrically conductive polymeric matrix material, and capacitors including the composite material according to the present teachings. The composite materials can further include a counterion.

According to various embodiments of the present teachings, a composite material including a plurality of nanotubes and an electrically conductive polymeric matrix, such as, for example, poly(3,4-ethylenedioxythiopene), is provided. According to various embodiments of the present teachings, poly(3,4-ethylenedioxythiopene) can be utilized as the electrically conductive polymeric matrix.

According to various embodiments of the present teachings, a counterion can also be in contact with or incorporated with the poly(3,4-ethylenedioxythiopene) to increase the electrical conductivity of the polymeric matrix. According to various embodiments of the present teachings, the counterion can be polystyrene sulfonic acid.

According to various embodiments of the present teachings, the poly(3,4-ethylenedioxythiopene) polymeric matrix material can have an electrical conductivity of at least about 10⁻¹⁰ Ω⁻¹/cm. According to various embodiments of the present teachings, the poly(3,4-ethylenedioxythiopene) polymeric matrix material can have an electrical conductivity ranging from about 10⁻¹⁰ Ω⁻¹/cm to about 10³ Ω⁻/cm, or ranging from about 10⁻⁶ Ω⁻¹/cm to about 10³ Ω⁻/cm, or ranging from about 10⁻¹ Ω¹/cm to about 10³ Ω⁻¹/cm.

According to various embodiments of the present teachings, the electrically conductive polymeric matrix can be poly(3,4-ethylenedioxythiopene) having from about eight to about 10,000 repeat units, or having from about eight to about 1,000 repeat units, or having from about eight to about 100 repeat units, or having from about 15 to about 20 repeat units.

According to various embodiments of the present teachings, the nanotubes can include single-walled carbon nanotubes, functionalized single-walled nanotubes, multiple-walled carbon nanotubes, and functionalized multiple-walled nanotubes. According to various embodiments of the present teachings, the nanotubes can have an outer diameter ranging from about 0.5 nm to about 1 nm, or ranging from about 1 nm to about 10 nm, or ranging from about 10 nm to about 25 nm, or ranging from about 25 nm to about 45 nm, or ranging from about 45 nm to about 100 nm. According to various embodiments of the present teachings, the nanotubes can be bundled together in groups of nanotubes numbering from about less than ten, from about less than five, or from about less than three.

According to various embodiments of the present teachings, nanotubes suitable for the present teachings can be formed by any suitable method, for example, laser ablation of carbon, decomposition of a hydrocarbon, or arcing between two carbon graphite electrodes. Numerous references describe suitable methods and starting materials to produce suitable carbon nanotubes. See, for example, U.S. Pat. Nos. 5,424,054 and 6,221,330; Smalley, R. E., et al., Chem. Phys. Lett. 243, pp. 1-12 (1995); and Smalley, R. E., et al., Science, 273, pp. 483-487 (1996). Suitable carbon nanotubes are commercially available from a number of sources. RFP single-walled nanotube (herein referred to as “RFP-SWNT”) is a soluble single-walled nanotube, which has been acid-purified and undergone subsequent processing to reduce functionality, and is available from Carbon Solutions, Inc. of Riverside, Calif. RFP-SWNT is understood to be prepared by a modified electric arc method, and have an aqueous solubility of about 0.1 mg per mL.

According to various embodiments of the present teachings, the nanotubes utilized according to the present teachings can be nanotubes that are dispersible in water, or a mixture of water and a co-solvent, such as, for example, ethylene glycol. According to various embodiments of the present teachings, the nanotubes can be functionalized with functional groups, for example, hydroxyl or carboxyl, to provide solubility in water or water/co-solvent mixtures.

According to various embodiments of the present teachings, the composite material can be composed to have a weight ratio of nanotube to polymeric matrix that is in the range of from about 0.05 to 1 to about 50 to 1. According to various embodiments of the present teachings, the weight ratio of nanotube to polymeric matrix can be about 2 to 1, or about 4 to 1, or about 5 to 1, or about 10 to 1, or about 15 to 1, or about 19 to 1.

According to various embodiments of the present teachings, the composite material can be optically transparent. Optically transparent refers to the transparency of the material in the visible wavelength range, and refers more specifically to the transmission of more than about 90%, or more than about 75%, or more than about 50%, or more than about 25%, or more than about 10% of the visible light.

According to various embodiments of the present teachings, a capacitor including a first electrode of a composite material comprising a plurality of nanotubes, an electrically conductive polymeric matrix, and a counterion; an electrolyte; and a second electrode is provided. According to various embodiments of the present teachings, poly(3,4-ethylenedioxythiopene) can be utilized as the electrically conductive polymeric matrix.

According to various embodiments of the present teachings, the first electrode can include a counterion that can also be in contact with or incorporated with the poly(3,4-ethylenedioxythiopene) to increase the electrical conductivity of the polymeric matrix. According to various embodiments of the present teachings, the counterion can be polystyrene sulfonic acid.

According to various embodiments of the present teachings, the poly(3,4-ethylenedioxythiopene) polymeric matrix material present in the first electrode can have an electrical conductivity of at least about 10⁻¹⁰ Ω⁻¹/cm. According to various embodiments of the present teachings, the poly(3,4-ethylenedioxythiopene) polymeric matrix material can have an electrical conductivity ranging from about 10⁻¹⁰ Ω⁻¹/cm to about 10³ Ω⁻¹/cm, or ranging from about 10⁻⁶ Ω⁻¹/cm to about 10³ Ω⁻¹/cm, or ranging from about 10⁻¹ Ω⁻¹/cm to about 10³ Ω⁻¹/cm.

According to various embodiments of the present teachings, the electrically conductive polymeric matrix of the first electrode can be poly(3,4-ethylenedioxythiopene) having from about eight to about 10,000 repeat units, or having from about eight to about 1,000 repeat units, or having from about eight to about 100 repeat units, or having from about 15 to about 20 repeat units.

According to various embodiments of the present teachings, the first electrode can include nanotubes which can be single-walled carbon nanotubes, functionalized single-walled nanotubes, multiple-walled carbon nanotubes, or functionalized multiple-walled nanotubes. According to various embodiments of the present teachings, the nanotubes can have an outer diameter ranging from about 0.5 nm to about 1 nm, or ranging from about 1 nm to about 10 nm, or ranging from about 10 nm to about 25 nm, or ranging from about 25 nm to about 45 nm. According to various embodiments of the present teachings, the nanotubes can be bundled together in groups of nanotubes numbering from about less than ten, from about less than five, or from about less than three.

According to various embodiments of the present teachings, the nanotubes utilized in the first electrode according to the present teachings can be nanotubes that are dispersible in water, or a mixture of water and a co-solvent, such as, for example, ethylene glycol. According to various embodiments of the present teachings, the nanotubes present in the first electrode can be functionalized with functional groups, for example, hydroxyl or carboxyl, to provide solubility in water or water/co-solvent mixtures.

According to various embodiments of the present teachings, the composite material of the first electrode can be composed to have a weight ratio of nanotube to polymeric matrix that is in the range of from about 0.05 to 1 to about 50 to 1. According to various embodiments of the present teachings, the weight ratio of nanotube to polymeric matrix can be about 2 to 1, or about 4 to 1, or about 5 to 1, or about 10 to 1, or about 15 to 1, or about 19 to 1.

According to various embodiments of the present teachings, the composite material of the first electrode can be optically transparent. Optically transparent refers to the transparency of the material in the visible wavelength range, and refers more specifically to the transmission of more than about 90%, or more than about 75%, or more than about 50%, or more than about 25%, or more than about 10% of the visible light.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The following examples are presented to provide a more complete understanding of the present teachings. The specific techniques, conditions, materials, and reported data set forth to illustrate the principles of the principles of the present teachings are exemplary and should not be construed as limiting the scope of the present teachings.

### EXAMPLES

Testing Procedures Raman Spectra—

Raman analyses were conducted on RFP-single-walled carbon nanotubes, poly(3,4-ethylenedioxythiopene), and samples prepared according to the procedures described in the Examples below. The Raman spectra were run at 532 nm.

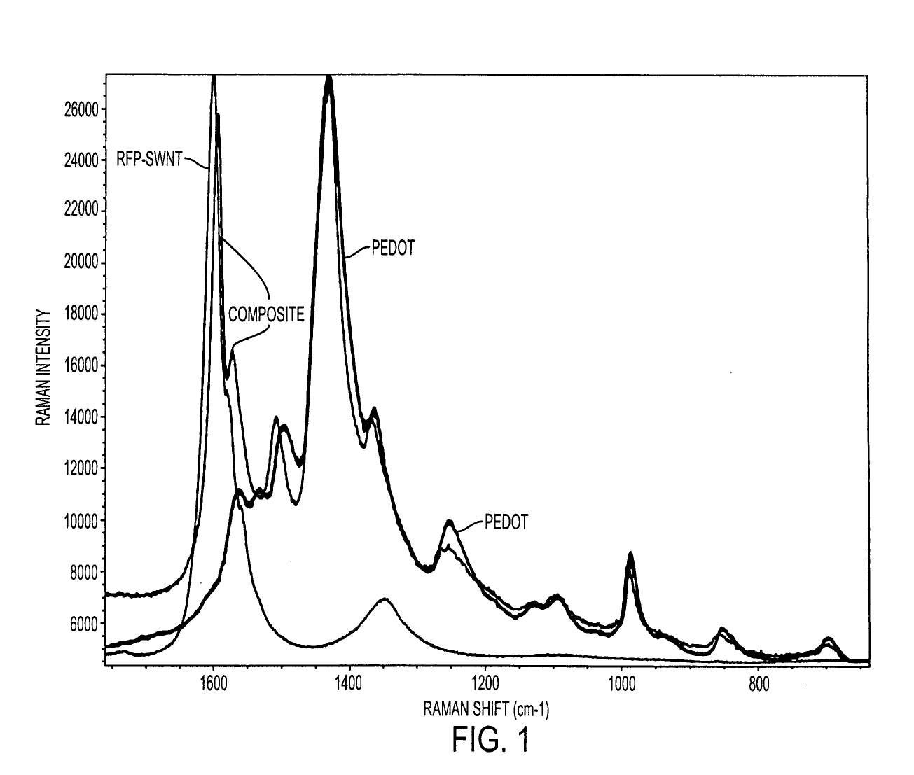

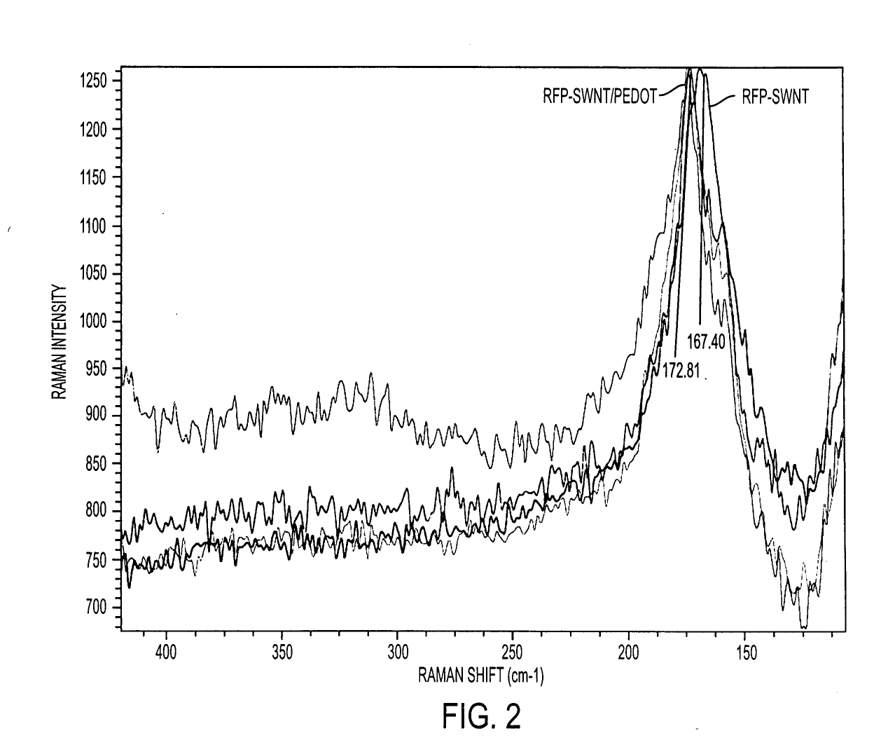

FIGS. 1 and 2 present the Raman spectra for a material prepared according to the procedures of the present teachings, PEDOT, and RFP-single-walled carbon nanotubes. FIG. 2 presents the spectra for three different spots or flakes of the material according to the present teachings compared against the spectrum for RFP-SWNT.

The interaction between the nanotubes and the polymer of the material prepared according to the present teachings has resulted in Raman peaks attributed to the nanotubes present in the material being shifted. These shifts are illustrated in both the shift to lower frequency of the tangential Raman mode at about 1600 cm⁻¹ as shown in FIG. 1, and the shift to higher frequency in the radial Raman mode, from about 167.40 cm⁻¹ to about 172.81 cm⁻¹, as shown in FIG. 2.

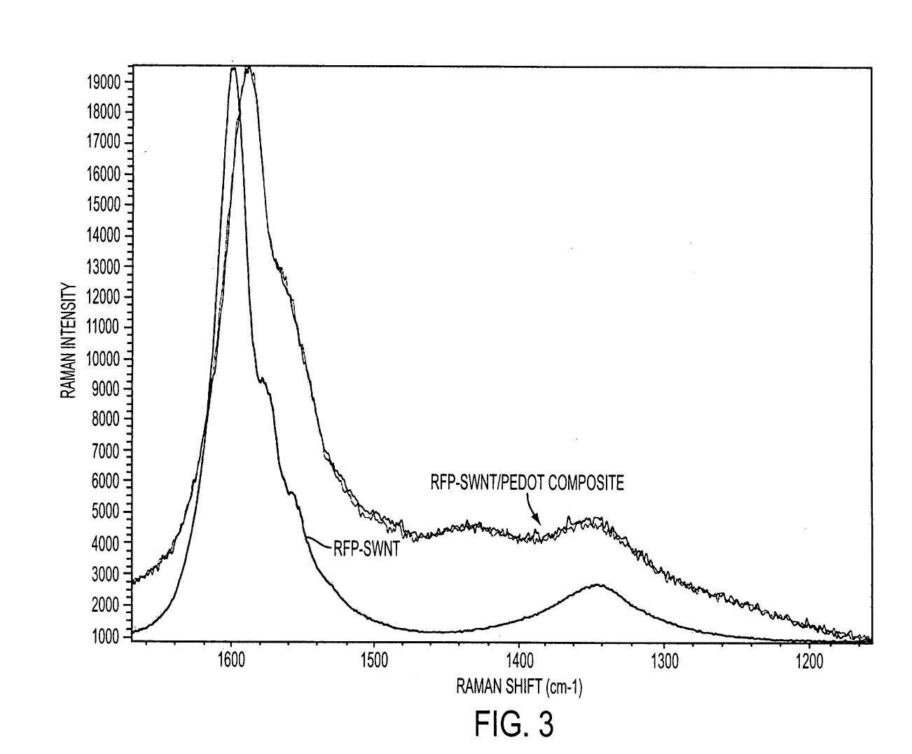

FIG. 3 presents the spectra for RFP-SWNT and two different spots or flakes of another material according to the present teachings. This material has a higher ratio of nanotube to polymer than the samples analyzed in FIGS. 1 and 2. The tangential Raman mode attributed to the nanotube, at about 1600 cm⁻¹, is shifted to lower frequency for the material according to the present teachings compared to the RFP-SWNT sample. The Raman mode at about 1440 cm⁻¹ is attributed to the PEDOT entity present in the material according to the present teachings.

Cyclic Voltammetry and Capacitance Measurements—

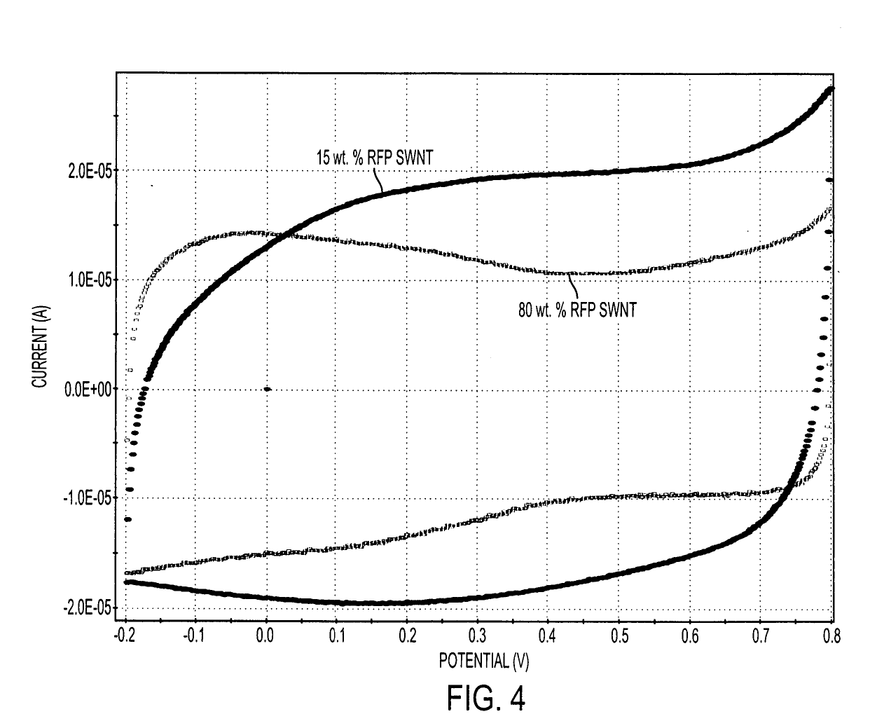

Cyclic voltammetric analyses were conducted on two examples according to the present teachings and the results are presented in FIG. 4. A composite material containing 15 wt. % RFP-SWNT and 85 wt. % poly(3,4-ethylenedioxythiopene) is represented by the ovals, while another composite material containing 80 wt. % RFP-SWNT, 10 wt. % KCl, and 10 wt. % poly(3,4-ethylenedioxythiopene) is represent by the rectangles. Samples of each respective material were attached to a glassy carbon electrode which then underwent cyclic voltammetric analyses.

FIG. 4 illustrates the results from the cyclic voltammetric analyses. The results show that at the lower nanotube concentration the material responds in a similar fashion to poly(3,4-ethylenedioxythiopene) without the nanotubes present; likewise at the higher nanotube concentration the material performs generally similar to the performance of a nanotube only composition.

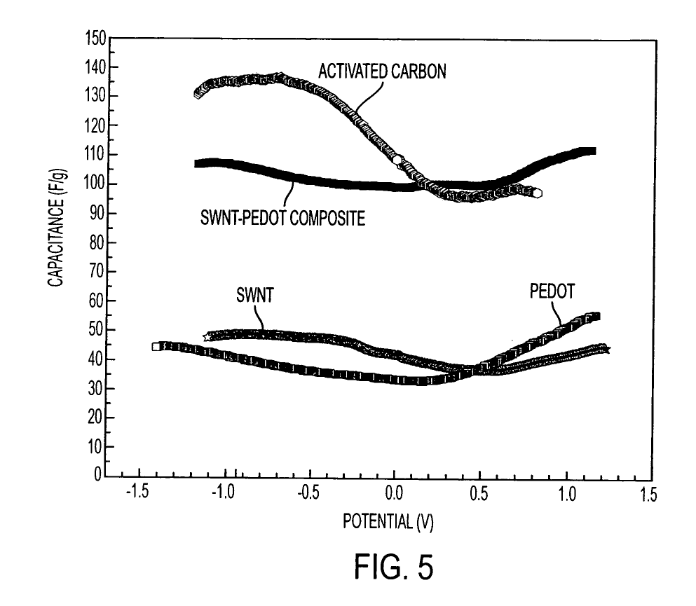

Capacitance measurements were conducted on four different materials and the results are presented in FIG. 5. A commercial available activated carbon, a composite containing 70 wt. % HiPco SWNT (single-walled carbon nanotubes prepare by a high pressure carbon monoxide process) and 30 wt. % poly(3,4-ethylenedioxythiopene), RFP-SWNT, and poly(3,4-ethylenedioxythiopene) were the four samples measured for capacitance.

The capacitance measurements presented in FIG. 5 illustrate the enhanced performance of nanotubes in combination with poly(3,4-ethylenedioxythiopene) and the comparative performance of a composite material according to the present teachings and a commercially available activated carbon typically used as material for a capacitor electrode.

### Example 1

A small flask charged with 2.0 mg RFP single-walled nanotube and 12.0 mL water was sonicated for five minutes. Potassium chloride was then added until solids appeared. The mixture was then sonicated for five minutes. Poly(3,4-ethylenedioxythiopene), 1.3 wt. % suspension (0.5 mL) in water was added, and the mixture sonicated for five minutes. The resulting mixture was dried under a hood by heating at about 60° C.

The nominal weight ratio of nanotube to polymer is 2 to 1.

### Example 2

A small flask charged with 0.10 mg RFP-SWNT and 18.0 mL water was sonicated for ten minutes. Poly(3,4-ethylenedioxythiopene), 1.3 wt. % suspension in water (0.05 mL) was added. The mixture was mixed, and then sonicated for five minutes. The resulting mixture was dried under a hood by heating at about 60° C.

The nominal weight ratio of nanotube to polymer is 1 to 1.

### Example 3

A small flask charged with 0.10 mg RFP-SWNT and 18.0 mL water was sonicated for 10 minutes. Poly(3,4-ethylenedioxythiopene), 1.3 wt. % suspension in water (0.01 mL) was added. The mixture was mixed, and then sonicated for five minutes. The resulting mixture was dried under a hood by heating at about 60° C.

The nominal weight ratio of nanotube to polymer is 5 to 1.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A composite material comprising:
a plurality of carbon nanotubes and
poly(3,4-ethylenedioxythiopene).

2. The composite material according to claim 1, further comprising a counterion.

3. The composite material according to claim 1, wherein the carbon nanotubes comprise at least one member selected from the group consisting of single-walled carbon nanotubes, multiple-walled carbon nanotubes, functionalized single-walled carbon nanotubes, and functionalized multiple-walled carbon nanotubes.

4. The composite material according to claim 1, wherein the carbon nanotubes comprise carbon nanotubes that are dispersible in water or a water/co-solvent mixture.

5. The composite material according to claim 3, wherein the co-solvent comprises ethylene glycol.

6. The composite material according to claim 1, wherein the weight ratio of carbon nanotube to the poly(3,4-ethylenedioxythiopene) is at least about 1 to 1.

7. The composite material according to claim 1, wherein the weight ratio of nanotube to the poly(3,4-ethylenedioxythiopene) ranges from about 1 to 1 to about 19 to 1.

8. The composite material according to claim 1, wherein the poly(3,4-ethylenedioxythiopene) comprises a poly(3,4-ethylenedioxythiopene) having an electrical conductivity of at least about 10⁻⁶ Ω⁻¹/cm.

9. The composite material according to claim 1, wherein the poly(3,4-ethylenedioxythiopene) comprises a poly(3,4-ethylenedioxythiopene) having an electrical conductivity ranging from between about 10⁻⁶ Ω⁻¹/cm to about 10³ Ω⁻¹/cm.

10. The composite material according to claim 1, wherein the poly(3,4-ethylenedioxythiopene) comprises a poly(3,4-ethylenedioxythiopene) having from about eight to about 10,000 repeat units.

11. The composite material according to claim 1, wherein the poly(3,4-ethylenedioxythiopene) comprises a poly(3,4-ethylenedioxythiopene) having from about eight to about 100 repeat units.

12. The composite material according to claim 1, wherein the poly(3,4-ethylenedioxythiopene) comprises a poly(3,4-ethylenedioxythiopene) having from about 15 to about 20 repeat units.

13. The composite material according to claim 1, wherein the counterion comprises polystyrene sulfonic acid.

14. The composite material according to claim 1, wherein the composite material is optically transparent.

15. A composite material comprising:
a plurality of carbon nanotubes,
poly(3,4-ethylenedioxythiopene), and
a counterion.

16. A capacitor comprising:
a first electrode comprising a composite material comprising:
a plurality of carbon nanotubes; poly(3,4-ethylenedioxythiopene); and a counterion, and
an electrolyte, and
a second electrode.

17. The capacitor according to claim 16, wherein the carbon nanotubes comprise at least one member selected from the group consisting of single-walled carbon nanotubes, multiple-walled carbon nanotubes, functionalized single-walled carbon nanotubes, and functionalized multiple-walled carbon nanotubes.

18. The capacitor according to claim 16, wherein the carbon nanotubes comprise carbon nanotubes that are dispersible in water or a water/co-solvent mixture.

19. The capacitor according to claim 18, wherein the co-solvent comprises ethylene glycol.

20. The capacitor according to claim 16, wherein the weight ratio of carbon nanotube to the poly(3,4-ethylenedioxythiopene) is at least about 1 to 1.

21. The capacitor according to claim 16, wherein the weight ratio of nanotube to the poly(3,4-ethylenedioxythiopene) ranges from about 1 to 1 to about 19 to 1.

22. The capacitor according to claim 16, wherein the poly(3,4-ethylenedioxythiopene) comprises a poly(3,4-ethylenedioxythiopene) having an electrical conductivity of at least about 10⁻⁶ Ω⁻¹/cm.

23. The capacitor according to claim 16, wherein the poly(3,4-ethylenedioxythiopene) comprises a poly(3,4-ethylenedioxythiopene) having an electrical conductivity ranging from between about 10⁻⁶ Ω⁻¹/cm to about 10³ Ω⁻¹/cm.

24. The capacitor according to claim 16, wherein the poly(3,4-ethylenedioxythiopene) comprises a poly(3,4-ethylenedioxythiopene) having from about eight to about 10,000 repeat units.

25. The capacitor according to claim 16, wherein the poly(3,4-ethylenedioxythiopene) comprises a poly(3,4-ethylenedioxythiopene) having from about eight to about 100 repeat units.

26. The capacitor according to claim 16, wherein the poly(3,4-ethylenedioxythiopene) comprises a poly(3,4-ethylenedioxythiopene) having from about 15 to about 20 repeat units.

27. The capacitor according to claim 16, wherein the counterion comprises polystyrene sulfonic acid.

28. The capacitor according to claim 16, wherein the composite material is optically transparent.

29. The capacitor according to claim 16, wherein the first electrode comprises a working electrode.
